(19) United States
(12) Patent Application Publication
(10) Pub. No.: US 2025/0160378 A1
(43) Pub. Date: May 22, 2025

(54) SOLID DELIVERY SYSTEMS

(71) Applicant: Firmenich SA, Satigny (CH)

(72) Inventors: Ronald SKIFF, Plainsboro, NJ (US); Luc ARMANET, Plainsboro, NJ (US)

(21) Appl. No.: 18/840,347

(22) PCT Filed: Feb. 23, 2023
(86) PCT No.: PCT/EP23/54520

§ 371 Date: Aug. 21, 2024

Related U.S. Application Data
(60) Provisional application No. 63/316,223, filed on Mar. 3, 2022.

(30) Foreign Application Priority Data
Mar. 18, 2022 (EP) 22163049.4

(51) Int. Cl. A23L 27/00; A23L 27/12; A23P 30/25; C11B 15/00; C12C 3/04

(52) U.S. Cl. CPC A23L 27/72; A23L 27/12; A23P 30/25; C11B 15/00; C12C 3/04

(57) ABSTRACT

Described herein are solid delivery systems including a high-terpene-content essential oil entrapped in an extruded carbohydrate matrix, as well as methods for producing such solid delivery systems. Such solid delivery systems are useful, for example, in imparting flavor or fragrance to consumer products such as brewed beverages.

### TECHNICAL FIELD

The present invention relates to solid delivery systems for the delivery of high-terpene-content essential oils, which systems include droplets of such essential oil entrapped in an extruded carbohydrate matrix.

### BACKGROUND

It is well known in the food and beverage industry that the addition of flavoring ingredients, including essential oils, contributes significantly to the palatability of consumable materials. For example, brewed beverages such as beer often include hop products, which—in addition to their functional use as a stabilizer and antimicrobial—also provide bitterness, flavor and aroma to the brewed beverage. However, high-terpene-content essential oils are subject to autooxidation and/or thermal degradation when exposed to air or heat. Therefore, there can be significant obstacles in formulating with such essential oils because of their limited processing temperature and shelf stability.

For example and specifically with regard to hop oils, brewing is a complex process that utilizes harsh conditions. Hop products are added at various points during this process and can be negatively affected by these harsh conditions. For example, certain components of the hop product can be stripped off or polymerized during boiling, and others may be absorbed into the yeast or filtered off during production. Given this, the amount of hop products that remain at the end of the brewing process is very low. Although hop products can be added to enhance taste after brewing, they are fairly unstable, being readily oxidized in air. Oxidized hop products have undesirable flavors and aromas, which means that hop products and hop derivatives tend to have a limited shelf life. Although there are presently available means to enhance the stability of hop products, they often include undesirable materials in terms of safety, storage, cost and consumer acceptance, such as ethanol or propylene glycol.

### SUMMARY

It is an object of the present invention, therefore, to deliver high-terpene-content essential oils in consumer products in a safe, effective and consistent manner. For example, in some embodiments, it is an object of the invention to deliver hop products to the brewing process or, in certain preferred embodiments, to a brewed beverage in a consistent manner that is safe and effective. Moreover, it would be advantageous to provide high-terpene-content essential oils, such as a hop oil, that is stable during transport and storage, even at ambient or elevated temperatures, and remains acceptable to consumers even after such transport and storage. To this end, the present teachings are directed to solid delivery systems that include high-terpene-content essential oil droplets entrapped in an extruded carbohydrate matrix.

In certain aspects, therefore, the present teachings are directed to methods for preparing the solid delivery systems disclosed herein. In general, such methods include:
a) blending a high-terpene-content essential oil with a carbohydrate matrix material, an emulsifier and optionally a plasticizer under temperature and stirring conditions to produce a uniform melt thereof;
b) extruding the uniform melt through a die;
c) optionally cooling the uniform melt;
d) chopping, cutting, grinding or pulverizing the uniform melt as it exits the die or after cooling to form the solid delivery system;
e) washing excess high-terpene-content essential oil from the surface of the solid delivery system; and
f) optionally drying the solid delivery system.

In some embodiments, the carbohydrate matrix comprises at least one carbohydrate selected from the group consisting of sucrose, glucose, lactose, levulose, fructose, maltose, ribose, dextrose, isomalt, sorbitol, mannitol, xylitol, lactitol, maltitol, pentatol, arabinose, pentose, xylose, galactose, trehalose, hydrogenated corn syrup, hydrogenated starch hydrolysates, maltodextrin, agar, carrageenan, gums, polydextrose, derivatives and mixtures thereof. In some embodiments, the carbohydrate matrix comprises maltodextrin or a mixture of maltodextrin and at least one material selected from the group consisting of sucrose, glucose, lactose, levulose, maltose, fructose, isomalt, sorbitol, mannitol, xylitol, lactitol, maltitol and hydrogenated corn syrup. In some embodiments, the maltodextrin has a DE equivalent less than 20. In some embodiments, the carbohydrate matrix includes at least 70% by weight of maltodextrin, relative to the total weight of the carbohydrate matrix. In other embodiments, the carbohydrate matrix consists essentially of or consists of maltodextrin.

In certain embodiments, the high-terpene-content essential oil is at least one essential oil selected from essential oils of Agarwood, Allspice, Anise, Basil, Bay leaf, Benzoin, Bergamot, Black Pepper, Buchu, Camphor, Cassia, Cedarwood, Celery, Chamomile, Cinnamon, Clove, Copaiba, Cumin, Cypress, Eucalyptus, Flax, Frankincense, Galangal, Ginger, Grapefruit, Guava, Hops, Hyssop, Jasmine, Juniper, Labdanum, Lavender, Lemon, Lemon grass, Lime, Manuka, Marjoram, Melaleuca, Myrrh, Nutmeg, Orange, Oregano, Patchouli, Peppermint, Pine, Plumeria, Rose, Rosemary, Rosewood, Sage, Sandalwood, Sassafras, Spearmint, Tangerine, Tea tree, Thyme, Tsuga, Valerian, Vetiver, White Fir, Wintergreen, and Ylang-ylang, and mixtures thereof. In some preferred embodiments, the high-terpene-content essential oil comprises hop oil.

In certain embodiments, the high-terpene-content essential oil is present in an amount of between about 3% and about 15%, relative to the total weight of the solid delivery system. In certain embodiments, the emulsifier includes at least one plant lecithin. In some embodiments, the solid delivery system includes a plant lecithin and the high-terpene-content essential oil is present in an amount greater than 9% by weight, relative to the total weight of the solid delivery system. In certain embodiments, the emulsifier is present in an amount of between 5% and 50%, relative to the weight of the high-terpene-content essential oil.

In some embodiments, the solid delivery system also includes a flavor, a fragrance, a nutrient, or a mixture thereof.

In some aspects, the present teachings are also directed to consumer products that include the solid delivery systems disclosed herein. In some embodiments, the consumer product is a brewed beverage.

In certain embodiments the high-terpene-content essential oil, carbohydrate matrix material, emulsifier and optionally plasticizer are stirred at a temperature maintained between 90° C. and 130° C.

In some embodiments, step a) includes:
a1) stirring the carbohydrate matrix material in the presence of a plasticizer, preferably wherein the plasticizer is water, at an elevated temperature, preferably at a temperature of between 110° C. and 120° C., to form a heated mixture; and
a2) adding to this heated mixture:
   i) a combination of the emulsifier and the high-terpene-content essential oil, or
   ii) the emulsifier, followed by subsequent addition of the high-terpene-content essential oil,
      preferably wherein step b) occurs within 60 minutes of adding the high-terpene-content essential oil, more preferably within 45 minutes of adding the high-terpene-content essential oil.

In certain embodiments, the water content is maintained between 5% and 10% by weight, relative to the total weight of the solid delivery system, during the preparation of the solid delivery systems disclosed herein.

In yet other aspects, the present teachings are directed to methods for preparing a solid delivery system, which methods include:
a1) stirring a carbohydrate matrix material in the presence of a plasticizer, preferably wherein the plasticizer is water, at an elevated temperature, preferably at a temperature of between 90° C. and 130° C., to form a heated mixture; and
a2) adding to this heated mixture:
   i) a combination of a plant lecithin and a high-terpene-content essential oil, or
   ii) the plant lecithin, followed by subsequent addition of the high-terpene-content essential oil,
to form a uniform melt
b) extruding the uniform melt through a die;
c) optionally cooling the uniform melt;
d) chopping, cutting, grinding or pulverizing the uniform melt as it exits the die or after cooling to form the solid delivery system;
e) washing excess high-terpene-content essential oil from the surface of the solid delivery system; and
f) drying the solid delivery system.

The present teachings also include solid delivery system obtainable by the method disclosed herein, preferably where the solid delivery system has a shelf-life of two years or greater when stored at ambient temperature.

### DETAILED DESCRIPTION

It has now been discovered that high-terpene-content essential oils can be encapsulated in a solid matrix using hot melt extrusion techniques to provide solid delivery systems having excellent shelf stability. The present disclosure, therefore, provides solid delivery systems that include droplets of high-terpene-content essential oils entrapped in an extruded carbohydrate matrix. Such solid delivery systems are cost effective and allow for the encapsulation of significant quantities of high-terpene-content essential oil, which is able to remain stable within the carbohydrate matrix for transportation or long storage periods and in some embodiments can be used to great effect during harsh processing techniques, such as brewing.

In some preferred embodiments, the solid delivery system of the present teachings consists essentially of, more preferably consists of, a high-terpene-content essential oil entrapped in a carbohydrate matrix. In other particularly preferred embodiments, the solid delivery system of the present teachings consists essentially of, more preferably consists of, a high-terpene-content essential oil entrapped in a maltodextrin matrix with an emulsifier. In still other particularly preferred embodiments, the solid delivery system of the present teachings consists essentially of, more preferably consists of, a hop oil entrapped in a maltodextrin matrix with a plant-lecithin emulsifier.

The solid delivery systems disclosed herein provide uniform distribution of the high-terpene-content essential oil in the matrix, which allows enhanced stability against degradation and oxidation. Uniform distribution of high-terpene-content essential oil in the matrix (and the related stability enhancement) in turn imparts a longer shelf-life relative to free high-terpene-content essential oil. For example, in some embodiments, the solid delivery systems disclosed herein have a shelf-life of at least about 6 months when stored at ambient temperature, for example for at least about a year or two or more in preferred embodiments. In some embodiments, the solid delivery systems disclosed herein have a shelf-life of at least 3, 4, 5 or even 6 years or more when stored at ambient temperature. As used herein, the term shelf-life refers to less than 20% degradation, preferably less than 10% degradation, of the high-terpene-content essential oil composition. The term shelf-life also refers to sensory acceptance of the high-terpene-content essential oil flavor or fragrance in the solid delivery system. Uniform distribution of high-terpene-content essential oil in the matrix also provides a product with consistent essential oil load, such that a perfumer, flavorist or brewer can be confident in the uniformity of taste or aroma across batches or brews.

It is also anticipated that the solid delivery systems disclosed herein will have improved organoleptic properties, including, for example, enhanced mouthfeel, enhanced masking effect of off-notes in the consumer product into which it is incorporated, and/or fuller and stronger impact of the high-terpene-content essential oil in the mouth and/or when ingested or inhaled.

### High-Terpene-Content Essential Oils

The solid delivery systems disclosed herein include at least one high-terpene-content essential oil. As used herein, the term “high-terpene-content essential oil” refers to an essential oil having a total content of terpenes that is greater than 50% by weight, relative to the weight of the essential oil. Essential oils refer to compounds extracted from various parts of a plant (e.g., bark, roots, leaves, flowers, fruit, etc.) that capture a scent and/or flavor from the plant. Typically essential oils are extracted using distillation, e.g., steam extraction and/or pressure extraction methods, but other methods may be used as known to a skilled artisan. “Terpenes” as used herein refer to the terpenes and terpenoid compounds that are present in such extracts. In some embodiments, the essential oil used in connection with the present teachings has a terpene content of greater than 60%, 70%, 80%, 90% or even greater than 95% by weight, relative to the weight of the essential oil. In some embodiments, the essential oil used in connection with the present teachings has a mono- and sesquiterpene content of greater than 50%, 60%, 70%, 80% or even greater than 90% by weight, relative to the weight of the essential oil. In some embodiments, the essential oil used in connection with the present teachings has a monoterpene content of greater than 50%, 60%, 70% or even greater than 80% by weight relative to the weight of the essential oil. In some embodiments, the essential oil used in connection with the present teachings has a sesquiterpene content of greater than 50%, 60%, 70% or even greater than 80% by weight relative to the weight of the essential oil.

Exemplary high-terpene-content essential oils may include, but are not limited to, essential oils of Agarwood, Allspice, Anise, Basil, Bay leaf, Benzoin, Bergamot, Black Pepper, Buchu, Camphor, Cassia, Cedarwood, Celery, Chamomile, Cinnamon, Clove, Copaiba, Cumin, Cypress, Eucalyptus, Flax, Frankincense, Galangal, Ginger, Grapefruit, Guava, Hops, Hyssop, Jasmine, Juniper, Labdanum, Lavender, Lemon, Lemon grass, Lime, Manuka, Marjoram, Melaleuca, Myrrh, Nutmeg, Orange, Oregano, Patchouli, Peppermint, Pine, Plumeria, Rose, Rosemary, Rosewood, Sage, Sandalwood, Sassafras, Spearmint, Tangerine, Tea tree, Thyme, Tsuga, Valerian, Vetiver, White Fir, Wintergreen, and Ylang-ylang.

Terpenes and terpenoid compounds present in such essential oils may include, but are not limited to monoterpenes such as limonene, pinene, terpinene, sabinene, myrcene, carene, phellandrene and thujene; and sesquiterpenes such as cedrene, thujopsene, bulnesene, humulene, guaiene, vatirenene, seychellane, cubebene, valencene, zingiberene, sesquiphellandrene, curcumene, germacrene, caryophyllene, farnesene, elemene, bisabolene, zingiberene; as well as hemiterpenes, diterpenes, etc.

In some embodiments, the high-terpene content essential oil does not comprise high-terpene content essential oils selected from the group consisting of grapefruit, lemon, lime, and orange.

In some embodiments, the solid delivery systems disclosed herein include at least one hop oil. As used herein, the term “hop oil” refers to at least one of a whole hop oil, a hop oil fraction, single hop oil constituents, blends of hop oil constituents, polyfunctional thiols, and hop oil derivatives. Whole hop oils can be obtained from hops using any of the methods known in the art. Hop oil fractions and constituents can be obtained by separation methods known in the art, including distillation, chromatography and/or partitioning. Similarly, hop oils may be derivatized by methods known in the art.

Hop oils may include monoterpene myrcene; sesquiterpenes such as humulene, β-caryophyllene or farnesene; monoterpene alcohols such as linalool and geraniol; oxygenated sesquiterpenoids such as cadinol, caryophyllene oxide, and humulenol II. Other hop constituents may also be present in the hop oils, including flavor or aroma compounds such as esters, ketones, alcohol and ethers.

The amount of high-terpene-content essential oil present in the solid delivery systems can vary. Generally speaking, solid delivery systems can be formulated to include an effective amount of the high-terpene-content essential oil. As used herein, the term “effective amount” refers to an amount sufficient to modify the aroma and/or flavor of a consumer product into which the solid delivery system is incorporated. For example, an effective amount of a hop oil refers to an amount of hop oil that is sufficient to modify the aroma and/or flavor of a brewed beverage into which the solid delivery system is incorporated.

In some embodiments, the solid delivery system includes high-terpene-content essential oil in an amount up to about 25%, e.g., between 1% and 25% by weight, relative to the total weight of the delivery system. In some embodiments, the solid delivery system includes high-terpene-content essential oil in an amount between 3% and 15% by weight, e.g., between 5% and 13% by weight relative to the total weight of the delivery system.

### Emulsifier

During manufacture of the solid delivery system disclosed herein, an emulsifier is used to stabilize the high-terpene-content essential oil and the matrix components, thus facilitating the entrapment of the high-terpene-content essential oil in the matrix. As used herein, the term “emulsifier” refers to an agent or compound that forms or preserves an emulsion. Suitable emulsifiers are known to those of skill in the art and include materials found in reference texts such as G. L. Hasenhuettl and R. W. Hartel, Food emulsifiers and their applications, 1997. Emulsifiers that are particularly useful with essential oils can be found, e.g., in Chilton et al. J Inst Brew, May-June 1978, 84:177-178. Fatty acid esters may also be used as emulsifiers in this context, including for example diacetyl tartaric acid ester of mono- and diglycerides (DATEM) and citric acid ester of mono and diglyceride (CITREM). Additional emulsifiers useful in connection with the present invention may be found, for example in Patent Publication Numbers US20220000136, US20200246245, US20170051236, WO2020104478, US20160073663, US20150351430, US20150282508, US20140154357, US20090041901, US20070009643, U.S. Pat. Nos. 4,242,366, 3,486,906, US20050026999, US20050220914, US20040151805, US20030096026 and US20020061354, US20020065328 to name just a few. The content of these publications relating to emulsification is incorporated herein by reference. In some embodiments, the emulsifier is a plant-based emulsifier. In some embodiments, it will be beneficial to use an emulsifier that is present in, or sourced from the same or similar material used in, the target consumer product. For example, in some embodiments, the consumer product is a brewed beverage and the emulsifier is sourced from wheat or barley.

Particularly suitable emulsifiers include animal or plant lecithins, such as soy lecithin or sunflower lecithin, as well as components thereof, such as one or a combination of glycerophospholipids. In one embodiment, the emulsifier is a soy lecithin or a sunflower lecithin. Sunflower lecithin may provide certain benefits because it is not considered an allergen. In some embodiments, the emulsifier is selected from one or more plant lecithins and the solid delivery system includes high-terpene-content essential oil in an amount greater than 8% by weight, e.g., in some embodiments 9% by weight or greater, relative to the total weight of the delivery system.

The amount of emulsifier used is not particularly limited, but will depend on the nature and amount of the other ingredients in the delivery system, as well as the effectiveness of the emulsifier itself. Generally speaking, the amount of emulsifier will be chosen relative to the weight of high-terpene-content essential oil used. In certain embodiments, the emulsifier is present in an amount of between 5% and 50% by weight, relative to the weight of the high-terpene-content essential oil. In the case of plant lecithins, it is possible to use a small amount, for example between 5 and 15% by weight, of emulsifier relative to the weight of the high-terpene-content essential oil. In some embodiments, the emulsifier is a plant lecithin, e.g., soy lecithin or preferably sunflower lecithin, present in an amount between 5% and 15% by weight, relative to the weight of the high-terpene-content essential oil.

### Carbohydrate Matrix

The matrix composition is based on the use of common polymeric saccharides, namely sugars and their derivatives. The solid delivery systems disclosed herein include a carbohydrate matrix. Carbohydrates that can be processed through extrusion techniques to form a dry extruded solid may be used as matrix materials in connection with the present teachings. Particularly useful carbohydrates include, but are not limited to sucrose, glucose, lactose, levulose, fructose, maltose, ribose, dextrose, isomalt, sorbitol, mannitol, xylitol, lactitol, maltitol, pentatol, arabinose, pentose, xylose, galactose, trehalose, hydrogenated corn syrup, hydrogenated starch hydrolysates, maltodextrin, agar, carrageenan, gums, polydextrose, derivatives and mixtures thereof.

According to certain preferred embodiments, the matrix material includes maltodextrin or mixtures of maltodextrin and at least one of sucrose, glucose, lactose, levulose, maltose, fructose, isomalt, sorbitol, mannitol, xylitol, lactitol, maltitol and hydrogenated corn syrup.

In some embodiments, maltodextrin having a particular dextrose equivalent is used. Dextrose equivalent, or “DE” is a measure of the amount of reducing sugars present in a sugar product, from which is derived the average degree of polymerization of the material. In some embodiments, the maltodextrin has a dextrose equivalent (DE) of 20 or less, e.g., less than 20, preferably 18.

In some embodiments, the carbohydrate matrix includes at least 70% by weight of maltodextrin, relative to the total weight of the carbohydrate matrix. In other embodiments, the carbohydrate matrix consists essentially of or consists of maltodextrin.

In some embodiments, the carbohydrate matrix material does not comprise hydrogenated starch hydrolysate.

In some embodiments, the carbohydrate matrix material does not comprise agar agar.

### Methods of Manufacture

The solid delivery systems of the invention can be produced by extrusion methods. In some embodiments, the present teachings provide a process for preparing a solid delivery system, the process including:
a) blending a high-terpene-content essential oil with a carbohydrate matrix material, an emulsifier and optionally a plasticizer under temperature and stirring conditions to produce a uniform melt thereof;
b) extruding the uniform melt through a die;
c) optionally cooling the uniform melt;
d) chopping, cutting, grinding or pulverizing the uniform melt as it exits the die or after cooling to form the solid delivery system;
e) washing excess high-terpene-content essential oil from the surface of the uniform melt or the solid delivery system; and
f) optionally drying the solid delivery system.

Typical conditions for this process are similar to those of processes for encapsulating hydrophobic flavors, as described for example in U.S. Pat. Nos. 4,610,890 and 4,707,367, the contents of which are hereby included by reference.

In certain embodiments of step a), the carbohydrate matrix material, the high-terpene-content essential oil, the emulsifier and the optional plasticizer (e.g., a certain amount of water) are mixed at a temperature near the melting point of the mixture, thus forming the uniform melt.

In other embodiments of step a), some ingredients are added to a heated mixture in a stepwise fashion. For example, one or more of the ingredients may be heated, e.g., in the presence of a plasticizer, followed by addition of one or more of the remainder of ingredients (either stepwise or in a bolus).

In some embodiments, step a) includes:
a1) stirring the carbohydrate matrix material in the presence of a plasticizer, preferably wherein the plasticizer is water, at an elevated temperature, preferably at a temperature of between 110° C. and 120° C., to form a heated mixture; and
a2) adding to this heated mixture:
   i) a combination of the emulsifier and the high-terpene-content essential oil, or
   ii) the emulsifier, followed by subsequent addition of the high-terpene-content essential oil.

In this embodiment, the conditions can be chosen to ensure minimal exposure of the high-terpene-content essential oil to moisture and heat. In certain embodiments, the addition of high-terpene-content essential oil occurs at least about 2 minutes, e.g., at least about 3, 4, 5, 6, 7, 8 or more minutes after the addition of the emulsifier. For example, in some preferred embodiments, the addition of high-terpene-content essential oil occurs between about 4 and about 8 minutes after the addition of the emulsifier. In certain preferred embodiments, step b) occurs within 60 minutes of adding the high-terpene-content essential oil to the heated mixture. In other embodiments, step b) occurs within 45 minutes or even within 30 minutes of adding the high-terpene-content essential oil to the heated mixture. In these embodiments, the carbohydrate matrix material, plasticizer, emulsifier mixture is typically stirred prior to addition of the high-terpene-content essential oil.

In certain embodiments of a1), the carbohydrate matrix material is combined with excess water (e.g., to generate a water content of between 15% and 20% by weight), and this mixture is heated to remove a portion of the excess water thus obtaining the desired or required water content (e.g., a water content of between 5% and 8% by weight).

Steps a) and b) are carried out at an appropriate temperature to maintain a uniform melt until desired cooling. Typically, this temperature is elevated, for example to at or above the boiling point of water or slightly above, but preferably not above 130° C. Thus, in certain embodiments, the high-terpene-content essential oil, carbohydrate matrix material, emulsifier and optionally plasticizer in step a) are stirred in at a temperature maintained between 90° C. and 130° C. In some embodiments, the temperature in steps a) and b) is maintained between 110° C. and 120° C., for example between 110° C. and 120° C. In some embodiments, this temperature is maintained within the boiling point of the molten mixture+/−5° C. In some embodiments, this temperature is maintained above the glass transition temperature of the carbohydrate matrix.

Extrusion of the uniform melt can be carried out using a number of techniques, depending on the size and properties desired in the final product. The methods described herein do not require special extruder equipment and can be carried out, for example, using a single or twin-screw extruder typically used in known “wet extrusion” or “dry blend” (also called “flash-flow”) techniques. Twin-screw extruders, single screw extruders, and ram extruders are commercially available, including those equipped with a cutter for chopping the extrudate and/or a temperature regulation mechanism for progressively increasing the temperature of the mixture as it progresses through the extruder to the die holes.

Moreover, the extruded solid may take one or more of various forms known in the art of extrusion, including, for example, powders of varied granulometry, rods, flakes, strands, filaments, and the like. The extruded solid may also be further processed, e.g., by grinding (or cryogrinding), pulverizing, crushing, chopping or sieving, to reduce its size. Such further processing might be appropriate, for example, where fine micronized powders are desired.

In some embodiments, the uniform melt is cooled as it is extruded through the die to a temperature below the glass transition temperature of the matrix. In still other embodiments, the uniform melt is extruded through the die above its glass transition temperature, and is cooled in a liquid solvent to lower the temperature to below its glass transition temperature (e.g., to form a glassy material). These embodiments produce a solid extruded material in the form of filaments or strands. The shape and size of these filaments or strands can be adjusted as a function of the extrusion parameters. Extruded granules or particles can then be made by, e.g., chopping, cutting, grinding, or otherwise breaking or crushing the cooled extruded material. Breaking or crushing, however, can lead to material having a large size distribution and may also damage the encapsulation around the high-terpene-content essential oil, thus adversely affecting the high-terpene-content essential oil loading in the matrix.

In other embodiments, the uniform melt is chopped or cut as it is extruded through the die in a plastic state above its glass transition temperature. Such techniques advantageously provide encapsulated material with a uniform size, which allow for a more uniform and kinetically well-defined release of the encapsulated high-terpene-content essential oil. In some embodiments, where a significant amount of plasticizer (e.g., water) is used in a so-called “wet granulation” technique, the method may require an additional drying step to remove the water/plasticizer. The solid delivery system may, therefore, be dried to a desired (or required, depending upon the application) moisture content. Efficient drying can be aided by the use of an anticaking agent such as silicon oxide, for example.

In some embodiments, the methods include a washing step, to wash the high-terpene-content essential oil from the surface of the product. The high-terpene-content essential oil may be washed from the surface of the uniform melt as it is extruded from the die or from the solid delivery system (i.e., once the uniform melt has cooled), or this step may occur as the material cools from a melt to a solid. For example, in some embodiments, the uniform melt is extruded, cooled in a solvent and chopped, cut, ground or otherwise broken into particles and it is the particles (i.e., particles of the solid delivery system) that are washed. In other embodiments, the uniform melt proceeds through a wash, e.g., a spray, as it is extruded from the die. In some embodiments, the high-terpene-content essential oils are washed from the surface of the uniform melt and/or the solid delivery system using a solvent. Although the solvent is not particularly limited, a solvent that does not significantly dissolve the carbohydrate matrix is preferred. In some embodiments, the solvent is cooled. Suitable solvents include alcohols such as methanol, ethanol, or isopropanol.

The temperature and pressure conditions under which the extrusion process is carried out are known to a person of ordinary skill in the art and can be adjusted to a particular extrudate without particular effort and as a function of the nature of the ingredients present in the melt and of the quality of the product which is desired to obtain, i.e. its granulometry, shape and size. In certain embodiments, the uniform melt is heated within an extruder, e.g., a twin screw-extruder, and extruded through an appropriately-sized die. Extrusion dies, which are known in the art, are typically thick, circular disks containing one or more openings having diameter(s) appropriate to create the desired profile; however, “die” is also used herein to refer to a nozzle or any other applicable opening situated at an appropriate position relative to the extruder. Diameters typically range from about 0.250 to about 10 mm and preferably from 0.7 to 2.0 mm. However, much higher diameters for the die are also possible. The die orifice is at the same temperature as that the rest of the apparatus, and may be equipped with a cutting device to chop the melt as it exits the die.

In some embodiments, the extruder assembly maintains the temperature of the mixture at a predetermined temperature, which is above the glass transition temperature of the carbohydrate matrix in order to keep the mixture in the form of a molten mass. Preferably the extruder assembly maintains the temperature of the mixture between 90° C. and 130° C. In some embodiments, the extruder exerts a predetermined pressure on the material moving through the die, which is adjusted to a value appropriate to maintain homogeneity of the melt. Typical pressures used in extrusion may reach as high as 100 bar (107 Pa), while preferred pressures are generally between 1 bar and 20 bar (between 10⁵ and 2×10⁶ Pa).

In certain embodiments, very little or no plasticizer is required for the methods described herein. In such embodiments where little or no plasticizer is present, it may be necessary to press-feed the extruder (e.g., under higher pressures) with the mixture (which may be in a substantially solid form) under efficient mixing, to ensure formation of a homogeneous melt and obtain a stable extruded product.

The glass transition temperature of the high-terpene-content essential oil/carbohydrate mixture depends on the amount of water added to the initial mixture. It is well known in the art that the Tg decreases when the proportion of water increases. Therefore, in certain embodiments, a small amount of water is used as the plasticiser in the methods described herein. Addition of a small amount of water can provide the uniform melt with a glass transition temperature (Tg) that is close to, preferably substantially the same as, the desired Tg of the final product. This is contrary to other methods such as wet-granulation, where the Tg of the mixture is quite different from the desired Tg of the final product. In some embodiments, water is added to obtain a Tg that is above room temperature and preferably above 40° C. Having a Tg above room temperature allows storage of the solid delivery system at ambient temperature in the form of free-flowing granules. In embodiments where the Tg of the uniform melt is close to, or substantially the same as, the desired Tg of the final product, it is possible to omit additional drying steps following extrusion.

Because the nature and amount of carbohydrate matrix material, emulsifier and high-terpene-content essential oil will vary, the water content utilized to achieve the desired Tg will also vary widely. In some embodiments, a water content of less than 10% by weight, relative to the total weight of the solid delivery system, is employed during mixing and maintained during extrusion of the uniform melt. In some embodiments, the carbohydrate matrix comprises a material having a DE (dextrose equivalent) of 18 and a water content of between 5% and 10% by weight, relative to the total weight of the solid delivery system, is employed during mixing and maintained during extrusion of the uniform melt.

### Applications

The present teachings are also directed, at least in part, to a consumer product comprising the solid delivery system described herein. The relevant consumer product will depend on the nature and identity of the high-terpene-content essential oil entrapped within the solid delivery system. For example, a wood oil (e.g., sandalwood oil) may be more suited for a personal care product whereas a fruit oil (e.g., lemon oil or an orange oil) may be more suited for a food product, such as a beverage.

In some embodiments, the high-terpene-content essential oil is a hop oil and the consumer product is a brewed beverage, e.g., beer. In some embodiments, the high-terpene-content essential oil is a hop oil and the consumer product is not a brewed beverage or an alcoholic beverage, but the solid delivery system is added to give a beer-like flavor thereto.

The concentrations in which the disclosed solid delivery systems can be incorporated in such consumer products varies widely and is dependent on the nature of the consumer product and the particular solid delivery system itself (e.g., the nature of the high-terpene-content essential oil incorporated into the solid delivery system). Typical concentrations include, but are not limited to concentrations ranging from a few parts per million (ppm) up to a few percent of the weight of the finished consumer product into which they are included.

A person of ordinary skill in the art, e.g., the art of brewing, would be able to select an appropriate concentration based on consumer preference for level of hoppiness. In some embodiments, the solid delivery system disclosed herein partially or completely replaces a sugar component, if present, in the consumer product.

At least partially as a result of the high-terpene-content essential oil being homogeneously and uniformly distributed and encapsulated within the carbohydrate matrix, the solid delivery systems disclosed herein provide stability against moisture and oxygen and prevent degradation of the high-terpene-content essential oil. Because the high-terpene-content essential oil can be loaded into the carbohydrate matrix in relatively high concentrations, and because the encapsulated high-terpene-content essential oil is less prone to oxidation/degradation, the solid delivery systems disclosed herein can be transported, handled, stored, and subsequently added to a consumer product when desired. For example, an encapsulated hop oil can be added directly into a brewed beverage, post fermentation.

In certain embodiments, the solid delivery systems disclosed herein are also able to survive harsh processing and or/manufacturing conditions better than unencapsulated essential oils. “Survive” as used herein, refers to the ability to maintain the essential oil in the consumer product in its desired form, whether that be identical to (or functionally the same as) the original essential oil or modified in a targeted way. For example, the solid delivery systems are able to survive heat processing, and/or chemical processing in certain embodiments, when incorporated into a consumer product. Particularly with regard to hop oils, solid delivery systems disclosed herein can, in certain embodiments, survive the brewing process better than unencapsulated hop oil. In some embodiments, therefore, the solid delivery systems disclosed herein are added to the brewing process, for example into the brew kettle, the whirlpool, the fermenter, the bright beer tank, prior to filtration, or any combination thereof. A person of ordinary skill in the art of brewing would be able to determine the type and amount of hop oil which would be most beneficial at any targeted stage of the brewing process. For example, humulene and β-caryophyllene terpenes in hop oils are susceptible to oxidation during the brewing process, potentially forming epoxides such as caryophyllene epoxide and humulene epoxides, among other oxidation products. Such epoxides may undergo further rearrangement into into allylic alcohols such as humulenol II, caryophyllenol and caryophylladienol. These oxidation and rearrangement products are more polar and can survive the brewing process and end up in the finished beer, where they typically impart spicy and herbal hop aromas characteristic for ‘kettle hop’ or ‘noble hop’ aroma such as found in traditional Pilsner type beers. The solid delivery system could then be manufactured specifically with that type and amount of hop oil and added to the brewing process specifically at the targeted stage.

In some embodiments, the solid delivery system also includes an additional hydrophobic flavor, a fragrance oil, a nutrient, or a mixture thereof. Such materials may be, for example, spices, herbs, fruit oils and extracts, botanical oils and extracts, or mixtures thereof. Flavors used in brewing include anise, chamomile, cardamom, chili, cinnamon, clove, coriander, fennel, fenugreek, ginger root, ginseng, hibiscus, lavender, lemongrass, juniper, lemon (peel), licorice root, lime (peel), peppercorn, peppermint, sweet orange (peel), bitter orange (peel), rooibos, rosehips, sage, stevia, tumeric and yerba mate.

If desired, adjuvants such as food grade colorants can also be added in a generally known manner to the solid delivery systems disclosed herein to provide colored solid delivery systems.

In certain embodiments, the present disclosure provides a kit or a flavor formulation intended to flavor a consumer product. The kit or formulation includes at least one solid delivery system disclosed herein, optionally in combination with one or more additional hydrophobic flavors, fragrance oils, or nutrients, which may also be separately incorporated into a solid matrix, e.g., a carbohydrate matrix.

### Exemplification

The invention will now be described in further detail by way of the following examples, which should not be construed as limiting.

### Example 1. Encapsulation of Hop Oil in Carbohydrate Matrix Using Soy Lecithin

TABLE 1
Formula details

| Ingredient | Quantity (g) |
|---|---|
| Sucrose | 1188.0 |
| 5DE MD | 1089.0 |
| 18DE MD | 363.0 |
| Hop Oil* | 300.0 |
| Emulsifier | Soy lecithin |
| Ratio Emulsifier/Oil | 0.1 |

*Hop Oil supplied by Kalsec, USA

A syrup mixture of sucrose and maltodextrins was prepared by dissolving the solids into demineralized water at a ratio solid/water of 80/20 by weight. The syrup mixture was heated to boiling. The temperature was increased to between 115° C. and 118° C. to reduce the water content to 7-8% w/w. The hot melt was kept at this elevated temperature and a mixture of oil and soy lecithin (ratio 10/1) was added to the hot melt and dispersed into small oil droplets via mechanical agitation.

The hot melt emulsion was extruded through a nozzle to form strands, which subsequently contacted an agitated bath of cold isopropyl alcohol to rapidly solidify the strands. The solid strands were washed (in the form of small irregular rods) using mechanical agitation in isopropyl alcohol. The resulting solid material was then collected from the isopropyl alcohol bath and dried.

The final product had a moisture content of 4.4-5.0% by weight (measured using Karl Fischer titration technique). Low field NMR technique confirmed that the final product, which is stable to oxidative degradation, contained between 9.4 and 10.0% oil by weight.

### Example 2. Encapsulation of High-Terpene-Content Essential Oil in Carbohydrate Matrix

The same process as set forth in Example 2 is used, except that the hop oil is replaced with one or more of the following high-terpene-content essential oils:
Lemon oil;
Grapefruit oil;
Orange oil;
Bergamot Oil;
Cedarwood Oil;
Patchouli Oil;
Vetiver Oil; or
Ginger Oil.

The resultant solid delivery systems have comparable loading and properties to Example 1, are easy to handle solids and are stable towards oxidative degradation. Example 3 Encapsulation of Hop Oil in Carbohydrate Matrix using Sunflower Lecithin

TABLE 3
Formula details

| Ingredient | Quantity (g) |
|---|---|
| Sucrose | 1188.0 |
| 5DE MD | 1089.0 |
| 18DE MD | 363.0 |
| Hop Oil* | 300.0 |
| Emulsifier | Sunflower lecithin |
| Ratio Emulsifier/Oil | 0.1 |

*Hop Oil supplied by Kalsec, USA

A syrup mixture of sucrose and maltodextrins was prepared by dissolving the solids into demineralized water at a ratio solid/water of 80/20 by weight. The syrup mixture was heated to boiling. The temperature was increased to between 115° C. and 118° C. to reduce the water content to 7-8% w/w. The hot melt was kept at this elevated temperature and a mixture of hop oil and sunflower lecithin (ratio 10/1) was added to the hot melt and dispersed into small oil droplets via mechanical agitation.

The hot melt emulsion was extruded through a nozzle to form strands, which subsequently contacted an agitated bath of cold isopropyl alcohol to rapidly solidify the strands. The solid strands were washed (in the form of small irregular rods) using mechanical agitation in isopropyl alcohol. The resulting solid material was then collected from the isopropyl alcohol bath and dried.

Low field NMR technique confirmed that the final product, which is stable to oxidative degradation, contained 9.3% oil by weight.

### Example 4 Encapsulation of Hop Oil Components

The same process as set forth in Example 1 is used, except that the hop oil is replaced with one or more of the following hop components, each of which may be sourced, for example, from Kalsec USA:
a liquid hop oil sesquiterpene fraction consisting of 31% beta-caryophyllene and 36% humulene.
a liquid hop oil fraction containing 55% sesquiterpene epoxides including caryophyllene epoxide, humulene epoxide I, II and III.
a liquid hop oil blend consisting of monoterpene and sesquiterpene hydrocarbons, monoterpene alcohols, epoxides, esters and ketones.

The resultant solid delivery systems have comparable loading and properties to Example 1, are easy to handle solids and are stable towards oxidative degradation.

### Example 5 Encapsulation of Hop Oil and Botanical Extract Blend

The same process as set forth in Example 1 is used, except that the hop oil is replaced with a liquid hop oil monoterpene fraction and blood orange botanical extract blend. The resultant solid delivery system has comparable loading and properties to Example 1, is an easy to handle solid and is stable towards oxidative degradation.

### Example 6 Encapsulation of Hop Oil Components and Natural Flavors

The same process as set forth in Example 1 is used, except that the hop oil is replaced with a liquid hop oil blend consisting of hop monoterpene and sesquiterpene hydrocarbons, hop monoterpene alcohols, hop epoxides, hop esters, hop ketones and other natural flavors derived from non-hop botanical sources. The resultant solid delivery system has comparable loading and properties to Example 1, is an easy to handle solid and is stable towards oxidative degradation.

### Example 7 Brewing Using Solid Delivery Systems

To wort produced from malted barley, wheat, other brewing grains, extracts of these brewing ingredients, or any combination thereof is added a solid delivery systems as substantially described in Examples 1 or 3-6, or combinations and variations thereof. The hopped wort is then converted into finished beer via traditional processes known to those skilled in the art, which could include boiling, separation of insoluble species, chilling the hopped wort, fermentation with yeast, conditioning, filtering, and other operations. The resulting beverage is characterized by pronounced hop aroma and flavor with no significant bitterness imparted by the encapsulated product. Alternatively, the encapsulated hop components are added to the sweet wort solution following the boiling step and/or at any point prior to fermentation of the sugars with yeast.

### Example 8 Post-Fermentation Addition of Solid Delivery Systems

To a fermented beverage generated via traditional processes known to those skilled in the art is added a suitable amount of a solid delivery system as substantially described in Examples 1 or 3-6, or combinations or variations thereof. The addition of encapsulated hop components is performed either before or after a final filtration of the beverage via methods known to those skilled in the art. The resulting beverage is characterized by pronounced hop aroma and flavor with no significant bitterness imparted by the encapsulated product.

### Example 9 Stability of Solid Delivery Systems Including High-Terpene-Content Essential Oils

An encapsulated essential oil prepared in accordance with the method described in Examples 1-6 is stored at ambient temperature for two years. The same essential oil blend (unencapsulated) with identical monoterpene and sesquiterpene composition is diluted to 0.1% in propylene glycol and 1% in ethanol, and is also stored at ambient temperature for two years. The data show that encapsulated hop oil compositions have surprisingly and significantly higher oxidative stability as compared to the liquid formulation with the identical essential oil blend.

After the two year storage period, both solid encapsulated product and liquid product in propylene glycol and ethanol are evaluated by analytical and sensory evaluation methods. Sensory evaluation with a trained panel demonstrates oxidized off flavors in the liquid products, while the flavor and aroma of the encapsulated essential oil have remained identical to the flavor and aroma of the same essential oil stored in the freezer for the same time period.

Analytical evaluations show an essential oil composition of the encapsulated essential oil after two years that is identical to the profile of the essential oil blend at the time of encapsulation. There are no signs of polymerization, oxidation or degradation of essential oil constituents. On the other hand, both liquid forms show evidence of polymerization and oxidation products of the terpenes.

1. A method for preparing a solid delivery system, the method comprising:
a) blending a high-terpene content essential oil with a carbohydrate matrix material, an emulsifier and optionally a plasticizer under temperature and stirring conditions to produce a uniform melt thereof;
b) extruding the uniform melt through a die;
c) optionally cooling the uniform melt;
d) chopping, cutting, grinding or pulverizing the uniform melt as it exits the die or after cooling to form the solid delivery system;
e) washing excess high-terpene content essential oil from the surface of the solid delivery system; and
f) optionally drying the solid delivery system.

2. The method of claim 1, wherein the high-terpene content essential oil, carbohydrate matrix material, emulsifier and optionally plasticizer are stirred at a temperature maintained between 90° C. and 130° C.

3. The method of claim 1, wherein
step a) comprises:
a1) stirring the carbohydrate matrix material in the presence of a plasticizer at an elevated temperature to form a heated mixture; and
a2) adding to this heated mixture:
i) a combination of the emulsifier and the high-terpene content essential oil, or
ii) the emulsifier, followed by subsequent addition of the high-terpene content essential oil.

4. The method according to claim 1, wherein water content is maintained between 5% and 10% by weight, relative to the total weight of the solid delivery system.

5. The method according to claim 1, wherein the carbohydrate matrix comprises at least one carbohydrate selected from the group consisting of sucrose, glucose, lactose, levulose, fructose, maltose, ribose, dextrose, isomalt, sorbitol, mannitol, xylitol, lactitol, maltitol, pentatol, arabinose, pentose, xylose, galactose, trehalose, hydrogenated corn syrup, hydrogenated starch hydrolysates, maltodextrin, agar, carrageenan, gums, polydextrose, derivatives and mixtures thereof.

6. The method according to claim 1, wherein the carbohydrate matrix comprises at least 70% by weight of maltodextrin, relative to the total weight of the carbohydrate matrix.

7. The method according to claim 1, wherein the high-terpene-content essential oil is at least one essential oil selected from the group consisting of essential oils of Agarwood, Allspice, Anise, Basil, Bay leaf, Benzoin, Bergamot, Black Pepper, Buchu, Camphor, Cassia, Cedarwood, Celery, Chamomile, Cinnamon, Clove, Copaiba, Cumin, Cypress, Eucalyptus, Flax, Frankincense, Galangal, Ginger, Grapefruit, Guava, Hops, Hyssop, Jasmine, Juniper, Labdanum, Lavender, Lemon, Lemon grass, Lime, Manuka, Marjoram, Melaleuca, Myrrh, Nutmeg, Orange, Oregano, Patchouli, Peppermint, Pine, Plumeria, Rose, Rosemary, Rosewood, Sage, Sandalwood, Sassafras, Spearmint, Tangerine, Tea tree, Thyme, Tsuga, Valerian, Vetiver, White Fir, Wintergreen, and Ylang-ylang, and mixtures thereof.

8. The method according to claim 1, wherein the high-terpene-content essential oil is present in an amount of between 3% and 15% by weight, relative to the total weight of the solid delivery system.

9. The method according to claim 1, wherein the emulsifier comprises one or more plant lecithins.

10. The method according to claim 1, wherein the emulsifier is present in an amount of between 5% and 50%, relative to the weight of the high-terpene-content essential oil.

11. The method according to claim 1, further comprising a flavor, a fragrance, a nutrient, or a mixture thereof.

12. A method for preparing a solid delivery system, the method comprising:
a1) stirring a carbohydrate matrix material in the presence of a plasticizer at an elevated temperature to form a heated mixture; and
a2) adding to this heated mixture:
i) a combination of a plant lecithin and a high-terpene-content essential oil, or
ii) the plant lecithin, followed by subsequent addition of the high-terpene-content essential oil,
to form a uniform melt
b) extruding the uniform melt through a die;
c) optionally cooling the uniform melt;
d) chopping, cutting, grinding or pulverizing the uniform melt as it exits the die or after cooling to form the solid delivery system;
e) washing excess high-terpene-content essential oil from the surface of the solid delivery system; and
f) drying the solid delivery system.

13. A solid delivery system obtained by the method according to claim 1.

14. The solid delivery system according to claim 13, wherein the emulsifier comprises at least one plant lecithin; wherein the high-terpene-content essential oil comprises hop oil which is present in an amount greater than 9% by weight, relative to the total weight of the solid delivery system.

15. A consumer product comprising the solid delivery system according to claim 13.

16. The method of claim 1, wherein step a) comprises:
a1) stirring the carbohydrate matrix material in the presence of a plasticizer, wherein the plasticizer is water, at a temperature between 110° C. and 120° C. to form a heated mixture; and
a2) adding to this heated mixture:
i) a combination of the emulsifier and the high-terpene content essential oil, or
ii) the emulsifier, followed by subsequent addition of the high-terpene content essential oil.

17. The method of claim 16, wherein step b) occurs within 60 minutes of adding the high-terpene content essential oil.

18. The method according to claim 1, wherein the carbohydrate matrix comprises maltodextrin or a mixture of maltodextrin and at least one material selected from the group consisting of sucrose, glucose, lactose, levulose, maltose, fructose, isomalt, sorbitol, mannitol, xylitol, lactitol, maltitol and hydrogenated corn syrup.

19. The method according to claim 1, wherein the carbohydrate matrix consists of maltodextrin.

20. The method according to claim 1, wherein the high-terpene-content essential oil comprises hop oil.
